(19) United States
(12) Patent Application Publication
(10) Pub. No.: US 2008/0301432 A1
(43) Pub. Date: Dec. 4, 2008

(54) Direct mail decoder product

(76) Inventor: Michael Turano, Lisle, IL (US)

Correspondence Address: MCDERMOTT, WILL & EMERY LLP, 227 WEST MONROE STREET, SUITE 4400, CHICAGO, IL, 60606-5096, US

(21) Appl. No.: 12/148,289

(22) Filed: Apr. 17, 2008

Related U.S. Application Data
(60) Provisional application No. 60/923,944, filed on Apr. 17, 2007.

(51) Int. Cl. H04L 9/06

(52) U.S. Cl. 713/150

(57) ABSTRACT

A direct mail decoder device is provided having a mailable carrier, an integral information panel, and an integral decoder. The carrier has a first side and a second side, and contact specific data, such as name and address information, on one of the first and second sides. The information panel is located on one of the first and second sides of the carrier, and contains encrypted information. The decoder is provided to decode the encrypted information.

### CROSS-REFERENCE TO RELATED APPLICATIONS

This application claims priority to U.S. Provisional Patent Application Ser. No. 60/923,944, filed on Apr. 17, 2007, which is expressly incorporated herein by reference and made a part hereof.

### FEDERALLY SPONSORED RESEARCH OR DEVELOPMENT

Not Applicable.

### TECHNICAL FIELD

The present invention relates generally to decoder devices, and more particularly to an integral decoder for direct mail products, including addressed direct mail, and decoders that decode variable information.

### BACKGROUND OF THE INVENTION

Decoders are well known in the art. Such decoders often utilize colored see-through materials to decode a code. While such decoders according to the prior art provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention provides a direct mail product generally comprising a carrier, an information panel and a decoder. According to one embodiment, the carrier is a mailable carrier having a first side and a second side. In one embodiment, the carrier is made of a paper substrate. The carrier may be a postcard, leaflet, direct mail insert, or other component that is preferably mailable.

According to another embodiment, contact specific data is provided as part of the direct mail product. In one embodiment the contact specific data is provided on one of the first or second sides of the carrier. The contact specific data may comprise name and address information.

According to another embodiment, a decoder is provided as part of the direct mail product. The decoder is capable of decoding the information, including encrypted information, found on the information panel. Depending on the type of encrypted information provided on the direct mail product, the decoder may comprise a colored see-through film.

According to another embodiment, the decoder may be integral with the carrier. However, in another embodiment the decoder may also be removable from the carrier.

According to another embodiment, the carrier has an aperture therethrough that extends from its first side to its second side. In such an embodiment the decoder may be positioned adjacent the aperture to substantially cover the aperture.

According to another embodiment, the decoder has a first surface facing toward the carrier and a second surface facing away from the carrier. A cavity may be located between the first surface of the decoder and the carrier. Additionally, an opening may be provided to provide access to the cavity. In such an embodiment the information panel may be removable from the carrier and adapted to be inserted through the opening and into the cavity between the carrier and the decoder to allow the encrypted information on the information panel to be decoded

According to another embodiment, the decoder is fixedly connected to the carrier adjacent the entire perimeter of the aperture.

According to another embodiment, an information panel is provided as part of the direct mail product. The information panel may be integral with the carrier and located on one of the first and second sides of the carrier. Additionally, the information panel may merely be an area on the carrier. In one embodiment the information panel contains encrypted information that is to be decoded by the decoder of the direct mail product. The encrypted information may be variable data, such as providing a variable code or a variable response. Additionally, the encrypted information may be encrypted in a coloring scheme.

According to another embodiment, the information panel is a removable from the carrier. Further, depending on the configuration of the decoder on the carrier, the information panel may be able to be repositioned between the decoder and the carrier.

According to another embodiment, the carrier has a bend area. The bend area may be provided between the information panel and the decoder. In such an embodiment the decoder is capable of being repositioned over the encrypted information to reveal the encrypted information.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a front view of one embodiment of a first direct mail decoder product;

FIG. 2 is a front view of a separated decoder panel and message panel of FIG. 1, with the decoder placed over the message panel to reveal the hidden message;

FIG. 3 is front view of one embodiment of a second direct mail decoder product;

FIG. 4 is a top view of the direct mail decoder product of FIG. 3;

FIG. 5 is a rear view of the direct mail decoder product of FIG. 3;

FIG. 6 is a front view of one embodiment of a third direct mail decoder product in a first position; and,

FIG. 7 is a front view of the direct mail decoder product of FIG. 6 in a second position.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Referring now to the Figures, there is shown direct mail decoder product 10 having a carrier 12 and an integral decoder 14. The direct mail decoder product 10 is an interactive component having encrypted information 16 on the carrier 12 that is decoded utilizing the integrated decoder 14, allowing the encoded information to be revealed to the user. The encoded information may be different information on different carriers 12.

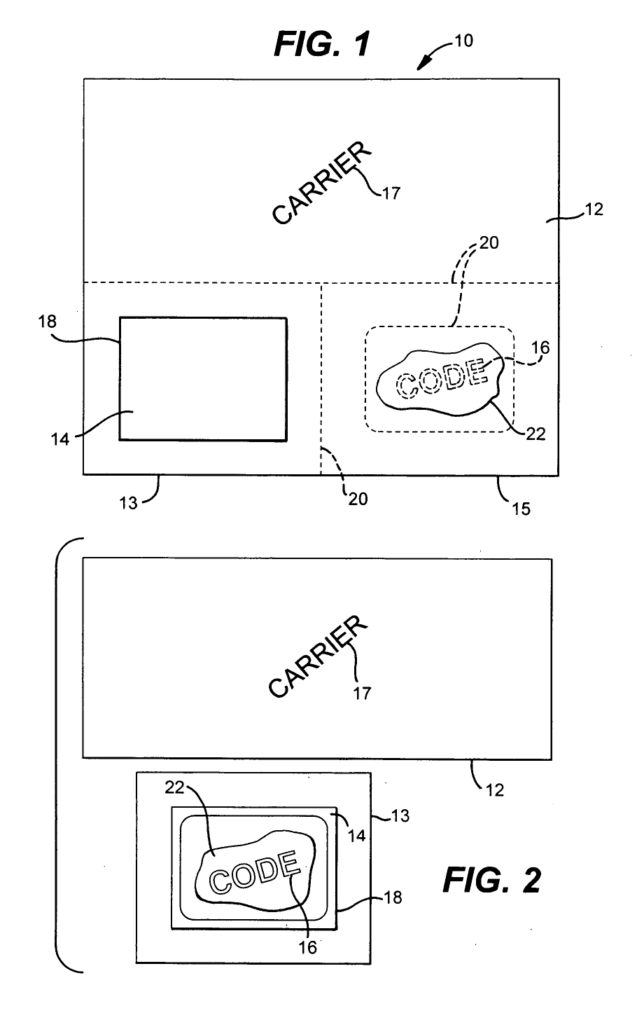

Various embodiments of the direct mail decoder product 10 are shown in the Figures. Referring to FIGS. 1 and 2, there is shown a first embodiment of the direct mail decoder product 10. The decoder product 10 comprises a carrier 12 with an integral decoder panel 13 having a decoder 14, and an integral message or information panel 15 having an encrypted or hidden message 16. The carrier 12 is typically made of a paper substrate, however, one of ordinary skill in the art would readily appreciate that other material may be used. The carrier 12 may have text 17 thereon in addition to the hidden message 16. In one embodiment the carrier 12 is an 8.5″ by 11″ piece of paper. In another embodiment the carrier 12 comprises a postcard, such as a 4″ by 6″ postcard. Preferably, the carrier 12 is a mailable component, such that it can be sent individually or together with other mail products through the U.S. Postal system. Often it is sent as a component of a direct mail product.

In one embodiment the decoder panel 13 of the carrier 12 has an aperture 18 or window 18 therethrough. Preferably, the window 18 is a die-cut aperture provided interior of the perimeter of the carrier 12. In this embodiment the decoder 14 is provided to substantially cover the opening in the window 18 of the decoder panel 13. The carrier 12 also has a variety of perforation lines 20 which allow a user to separate the decoder panel 13 and the message panel 15 from the remainder of the carrier 12. Alternatively, in another embodiment either the decoder panel 13 or the message panel 15 may remain connected to the carrier 12 while the other of the decoder panel 13 or the encrypted message panel 15 remains affixed to the carrier 12.

In one embodiment the encrypted message 16 is generally a text message having a certain color that is hidden within artwork 22, which includes an area of a different color. In such an embodiment, the encrypted message 16 becomes visible to the user when the decoder 14 is placed over the artwork 22, as shown in FIGS. 2 and 7.

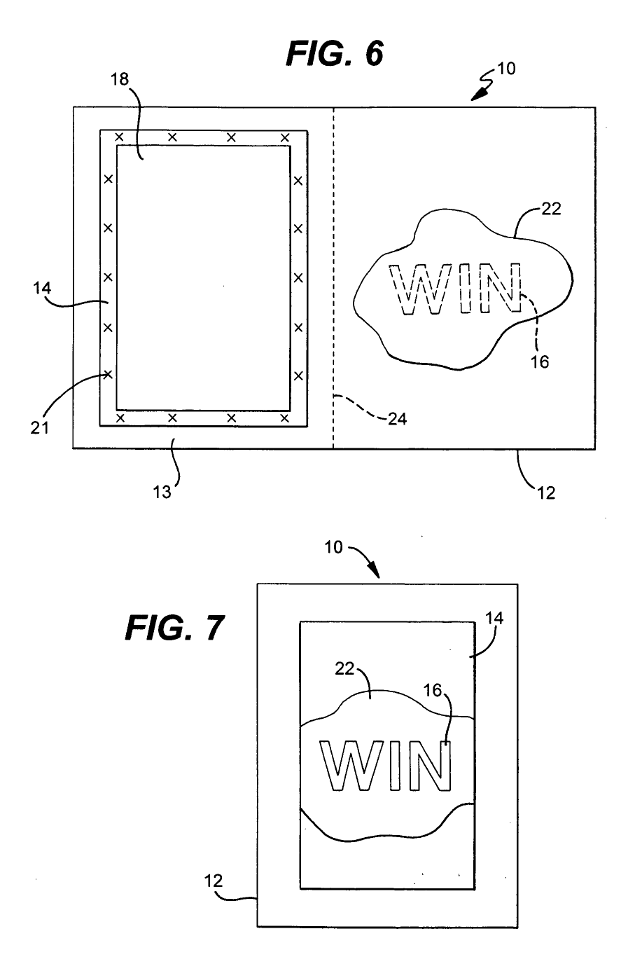

According to a preferred embodiment, the decoder 14 comprises a cellophane material. Cellophane is generally a thin, transparent sheet material made of processed cellulose. In other embodiments, however, the decoder 14 may be made of a different see-through material, such as a plastic or glass. It is preferred that the decoder 14 be made of a material that is transparent and thus has the property of transmitting light without appreciable scattering so that bodies lying beyond are seen clearly. Additionally, in the preferred embodiments the decoder 14 is made of a colored material such that the color of the decoder 14, when combined with or placed over the color of the encrypted message 16 in the artwork 22, allows the encrypted message 16 to be visible or revealed to the user. In one embodiment the cellophane material that comprises the decoder 14 is generally connected about its periphery at connection points 21 (as shown in FIGS. 5 and 6) to the decoder panel 13 at the edges of the window 18.

Referring again to FIGS. 1 and 2, in this embodiment the user may remove either the decoder panel 13 containing the decoder 14, the encrypted message panel 15 containing the encrypted message 16, or both panels 13, 15 from the carrier 12. Such removal is typically provided for by tearing the appropriate panel 13, 15 from the carrier 12 at the appropriate perforation lines 20. As shown in FIG. 2, the user then places the decoder 14 over the artwork 22 to reveal the hidden or encrypted message 16 through the window 18 in the decoder panel 13.

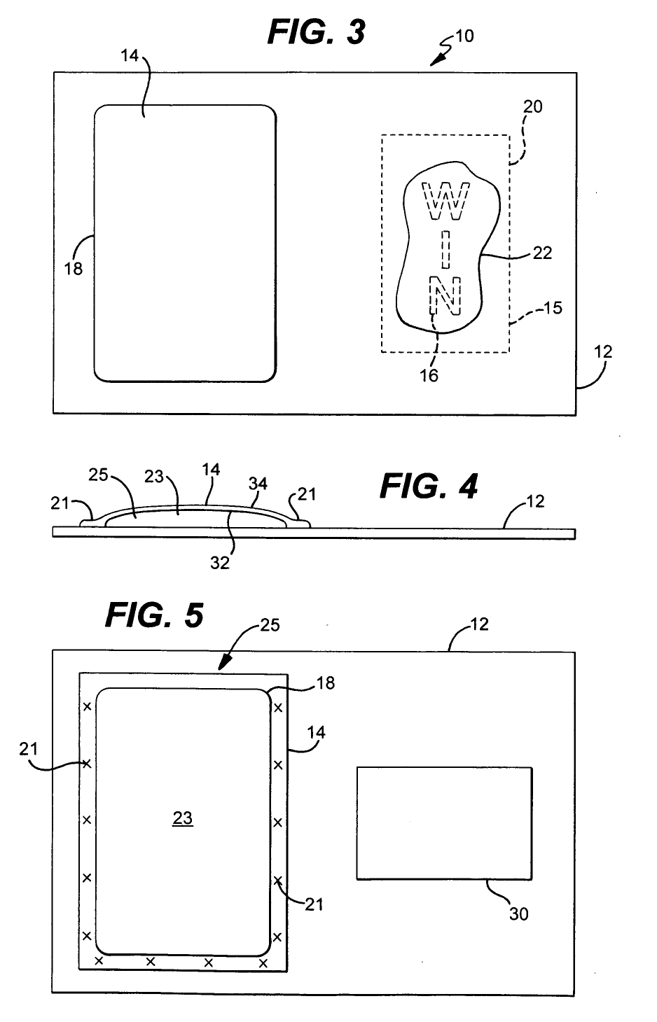

Referring now to FIGS. 3-5, another embodiment of the decoder product 10 is disclosed. In this embodiment the carrier 12 comprises a postcard, such as a 4″ by 6″ card. The carrier 12 has a decoder panel 13 with a decoder 14 provided in a window 18 thereof, and a hidden message panel 15 containing the encrypted or hidden message 16 in block 22. As shown in FIG. 5, the decoder product 10 may have an area for a contact specific data 30, such as a name and address, on the carrier 12. This allows the decoder product 10 to be individually sent in the mail, to allow the decoder product 10 to be direct mailed to the user. One area for this contact specific data 30 is on the opposing side of the carrier 12 as the artwork 22 containing the hidden message 16. Preferably, however, the direct mail postcard has the address 24 either directly on the carrier 12 or on a label that is placed directly on the carrier 12. In this embodiment, a plurality of perforation lines 20 allow the hidden message panel 15 to be completely separated from the carrier 12.

As shown in FIG. 4, in one embodiment the decoder 14 is connected to the decoder panel 13 to create a cavity 23, which may be in the form of a pocket 23. To form the cavity 23, the decoder 14 is connected, typically with an adhesive at connection points 21, to the decoder panel 13 at a plurality, but not all, of its sides, or not its entire perimeter. In one embodiment the decoder 14 comprises a rectangular panel having four sides and two surfaces. In such an embodiment two opposing sides, or three adjacent sides, of the decoder 14 may be connected to the decoder panel 13 adjacent the window 18. The portion or side of the decoder 14 not connected to the carrier 12 creates the opening 25 to the cavity 23. Further, in this embodiment the first surface 32 of the decoder 14 faces toward the carrier 12, and the second surface 34 of the decoder 14 faces away from the carrier 12. The hidden message panel 15 has a size that fits within the cavity 23, between the carrier 12 and the first surface 32 of the decoder 14. The user can then insert the hidden message panel 15 into the opening 25 of cavity 23 created by the partial connection of the decoder 14 to the decoder panel 13 to allow the hidden message 14 to be revealed by the decoder 14. In alternate embodiments multiple openings 25 to the cavity 23 may be provided.

Another embodiment of the direct mail decoder product 10 is shown in FIGS. 6 and 7. In this embodiment the carrier 12 comprises a foldable member, which is foldable about the fold line 24 in a bend area as shown in FIG. 6, to create a first member 26 and a second member 28 on opposing sides of the fold line 24. The first member 26 has a window 18 with a decoder 14 therein. The second member 28 has artwork 22 with a hidden message 16 therein. To reveal the hidden message 16 the first member 26 is folded over the second member 28 at the fold line 24 thereof, and the decoder 14 is positioned over the artwork 22 in this second position as shown in FIG. 7 to reveal the hidden message 16 to the user.

The decoder product 10 typically is provided as a direct mail component, mailed either directly itself or as a component of a direct mail package.

In another embodiment not shown, the decoder panel 13 with the decoder 14 may be removable from the carrier 12 to be utilized on various areas of the carrier 12 or on different pages of the carrier 12 to reveal different hidden messages 16 throughout the carrier 12. For example, the carrier 12 may be a multiple page leaflet, such as in a magazine or book style. Various pages may have different hidden messages 16. By having a removable decoder panel 13, the decoder 14 can be used to unveil the different messages 16 on the various pages of the carrier 12.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention.

What is claimed is:

1. A direct mail decoder device, comprising: a mailable carrier having a first side and a second side, and contact specific data on one of the first and second sides, an information panel integral with the carrier and located on one of the first and second sides of the carrier, the information panel having encrypted information, and a decoder integral with the carrier, the decoder capable of decoding the encrypted information.

2. The direct mail decoder of claim 1, wherein the encrypted information is variable data.

3. The direct mail decoder of claim 1, wherein the contact specific data contains name and address information.

4. The direct mail decoder of claim 1, wherein the information panel is removable from the carrier.

5. The direct mail decoder of claim 4, wherein the information panel can be repositioned between the decoder and the carrier.

6. The direct mail decoder of claim 1, wherein the decoder is removable from the carrier.

7. The direct mail decoder of claim 1, wherein the decoder comprises a colored see-through film.

8. The direct mail decoder of claim 7, wherein carrier has an aperture therethrough that extends from the first side to the second side thereof, and wherein the decoder is positioned to substantially cover the aperture.

9. The direct mail decoder of claim 1, further comprising an opening between the decoder and the carrier, wherein the information panel is removable from the carrier, and wherein the information panel can extend through the opening and be repositioned between the carrier and the decoder.

10. The direct mail decoder of claim 1, further comprising a bend area between the information panel having encrypted information and the decoder, and wherein the decoder can be repositioned over the encrypted information to reveal the encrypted information.

11. A direct mail decoder device, comprising: a mailable carrier having a first side and a second side, an information panel containing encrypted information, the information panel integral with the carrier and located on one of the first and second sides of the carrier, an aperture extending through the carrier from the first side to the second side thereof, and an integral decoder capable of decoding the encrypted information, the decoder connected to the carrier adjacent the aperture and generally covering the aperture.

12. The direct mail decoder of claim 11, further comprising contact specific data on one of the first and second sides of the carrier.

13. The direct mail decoder of claim 11, wherein the encrypted information is encrypted in a coloring scheme.

14. The direct mail decoder of claim 13, wherein the decoder comprises a colored see-through film.

15. The direct mail decoder of claim 11, wherein the decoder is fixedly connected to the carrier adjacent the entire perimeter of the aperture.

16. The direct mail decoder of claim 11, wherein the information panel and the decoder are removable from the carrier.

17. A direct mail decoder device, comprising: a mailable paper substrate carrier having a first side and a second side, an information panel containing encrypted information being integral with the carrier and located on one of the first and second sides of the carrier, an integral see-through colored decoder capable of decoding the encrypted information being connected to one of the first and second sides of the carrier, the decoder having a first surface facing toward the carrier and a second surface facing away from the carrier, a cavity located between the first surface of the decoder and the carrier, and an opening providing access to the cavity, wherein the information panel is removable from the carrier and is adapted to be inserted through the opening and into the cavity to decode the encrypted information on the information panel.

18. The direct mail decoder of claim 17, further comprising contact specific data on one of the first and second sides of the carrier.

19. The direct mail decoder of claim 17, wherein the contact specific data contains name and address information.

20. The direct mail decoder of claim 17, wherein the decoder is removable from the carrier.
